(19) United States
(12) Patent Application Publication
(10) Pub. No.: US 2010/0185734 A1
(43) Pub. Date: Jul. 22, 2010

(54) METHOD FOR PROCESSING RESPONSE MESSAGES

(75) Inventor: Chung-Yung Shen, Shing Tien City (TW)

Correspondence Address: MOXA INC., P.O.BOX 108-00403, TAIPEI, 106, omitted

(73) Assignee: MOXA INC., Shing Tien City (TW)

(21) Appl. No.: 12/355,801

(22) Filed: Jan. 19, 2009

(51) Int. Cl. G06F 15/16; H04L 12/28

(52) U.S. Cl. 709/206; 370/392

(57) ABSTRACT

This present invention relates to a method for processing response messages, comprising a transmitter, first communication gateway, second communication gateway and a receiver, wherein the transmitter is connected with the first communication gateway, while the receiver is linked with the second communication gateway. When a message is transmitted by the transmitter via a mobile communication network to a remote receiver, the second communication gateway will transmit a response message to the transmitter after the transmitter receives the message. The first communication gateway will determine that the receiver does not receive the message successfully if it does not receive the response message within a given time period, and then transmit the message again or inform the administrator. In this way, it can help reduce the loss of property and life to enterprises and their employees caused by loss of messages. In addition, the second communication gateway will decide if the message is valid or not upon receipt. If the message is invalid, transmission to the receiver will be terminated. This can prevent sending a packet repeatedly due to failure of the transmitter, or prevent hogging of receivers' bandwidth by messages from unknown sources as a result of hackers' intrusion.

### BACKGROUND OF THE INVENTION

1. Field of the Invention

The present invention relates to a method for processing response messages, wherein a transmitter is utilized to deliver a message to a receiver. When the receiver receives the message, a second communication gateway connected with it will send a response message back to a first communication gateway that is connected with the transmitter. This method allows the transmitter to decide if the receiver has really received the message or not, thus reducing the loss of property and life to enterprises and their employees possibly due to loss of messages.

2. Description of the Prior Art

With continued progress in communication technologies, communication equipments have evolved from wired telephones and pagers into mobile phones of the 1st, 2nd and 3rd generations, and have gradually shifted from voice transmission through analog signals that was only available at the beginning to include information transmission via digital signals. As a result, users will gain wider access to diversified communication modes. Again, due to progress in mobile communication technology and gradual popularity of base stations installed, industrial control equipments begin to rely on mobile communication networks to perform remote control-related operations. Especially in remote areas and even areas that are difficult to wire, enterprises can utilize mobile communication networks to transmit information or data to and from industrial control equipments at remote sites. Such means of remote control will enable enterprises to understand the status of industrial control equipments in remote locations and take control over these devices effectively and remotely.

The aforesaid methods of digital signal transmission are adopted in circuit switched data (CSD), short message service (SMS) and general packet radio service (GPRS), etc. For CSD service, it will occupy the resources for voice channels while digital signals are transmitted, which will result in such troubles where users cannot make phone call. On the other hand, while users make phone call, they also cannot transmit digital signals via Internet at the same time. In addition, this technology has its limitations because of its unavailability for use by the general public in some areas. Whether GPRS or CSD is used, the costs are much higher than SMS. Therefore, SMS has become the digital transmission technology more commonly used at present.

However, such SMS technology does not provide any safety mechanism. In another word, a transmitter does not know whether the short messages it sends are received by a given receiver successfully. Thus, it is possible to suffer heavy losses when the transmitter sends a warning message but the receiver does not receive such message successfully. In rainfall or water level monitoring, for example, when the rainfall or water level is found to be abnormal, warning messages can be transmitted from a remote location to master control equipment inside an enterprise for performing necessary operations. If the master control equipment does not receive the message(s) due to busy lines or other reasons at this moment, and the transmitter does not know that the receiver has not got the message(s), the enterprise will not be able to react immediately. Any delay in reaction may result in flooding of rivers and further lead to severe casualties. On the other hand, for monitoring of debris flows in mountainous regions, irreparable damages as indicated above may be caused possibly because the transmitter does not know whether the receiver gets important messages successfully.

Thus, how to solve the common problems and disadvantages as mentioned above is just what the firms involved in this industry need urgently to research and improve.

### SUMMARY OF THE INVENTION

In view of the problems and disadvantages mentioned above, the inventor, after collecting related information and inviting assessments and reviews from various parties, relying on many years of experience in this industry and through continuous trials and corrections, has finally invented the method for processing response messages.

An objective of the present invention is to reduce the possibilities that a transmitter cannot immediately learn about and handle the cases in which a receiver does not receive messages from the transmitter, wherein the transmitter is connected with a first communication gateway, while the receiver is linked with a second communication gateway. When the transmitter tries to rely on the first communication gateway for transmitting a message to the receiver via a mobile communication network and the second communication gateway in sequence, the first communication gateway will, after a certain period of time, decide if it has received a response message returned by the second communication gateway through the mobile communication network. The first communication gateway will automatically transmit the message again if it decides that no message is received within a certain period of time, thus reducing potential financial losses to enterprises and safety risks on employees due to unsuccessful transmission of messages to the receiver.

Another objective of the present invention is to ensure that the first communication gateway will send warning messages to the transmitter when it decides after a certain period of time that the message is not received. Such way of active and timely notification to administrators will enable them to learn and handle unsuccessful transmission of messages immediately without any delay in communication of important information, thus further enhancing reliability in transmission of messages.

The third objective of the present invention is to ensure that the second communication gateway, when receiving a message, can decide if the Auth ID preceding the message is the same as the preset value in the memory. If not, continued transmission of the message to the receiver will be prohibited. This can prevent bandwidth hogging due to hackers' intrusion or prevent other unnecessary messages from going into the receiver.

The fourth objective of the present invention is to make sure that the second communication gateway, when receiving a message, will decide if the preceding message ID is the same as the value stored in the memory. If so, it will judge that the message is a packet of repeated transmission. In this context, it will prevent the message from being further transmitted to the receiver. This will effectively reduce the possibilities where the transmitter continues to deliver the same messages repeatedly as a result of its failure, which may make the receiver get these messages continuously and further lead to system damages and bandwidth payloads.

### BRIEF DESCRIPTION OF THE DRAWINGS

FIG. 1 is a block diagram according to one embodiment of the present invention.

FIG. 2 is a flow chart illustrating detection and processing according to one example of the preferred embodiments of the present invention.

FIG. 3 schematically illustrates a message packet according to one example of the preferred embodiments of the present invention.

FIG. 4 is a schematic diagram according to one example of the preferred embodiments of the present invention.

### DETAIL DESCRIPTION OF THE INVENTION

In order to achieve the objectives and functions stated above as well as the technology and framework adopted in the present invention, some examples of the preferred embodiments of are illustrated in detail with reference to the accompanying drawings to fully describe the features and functions of the present invention.

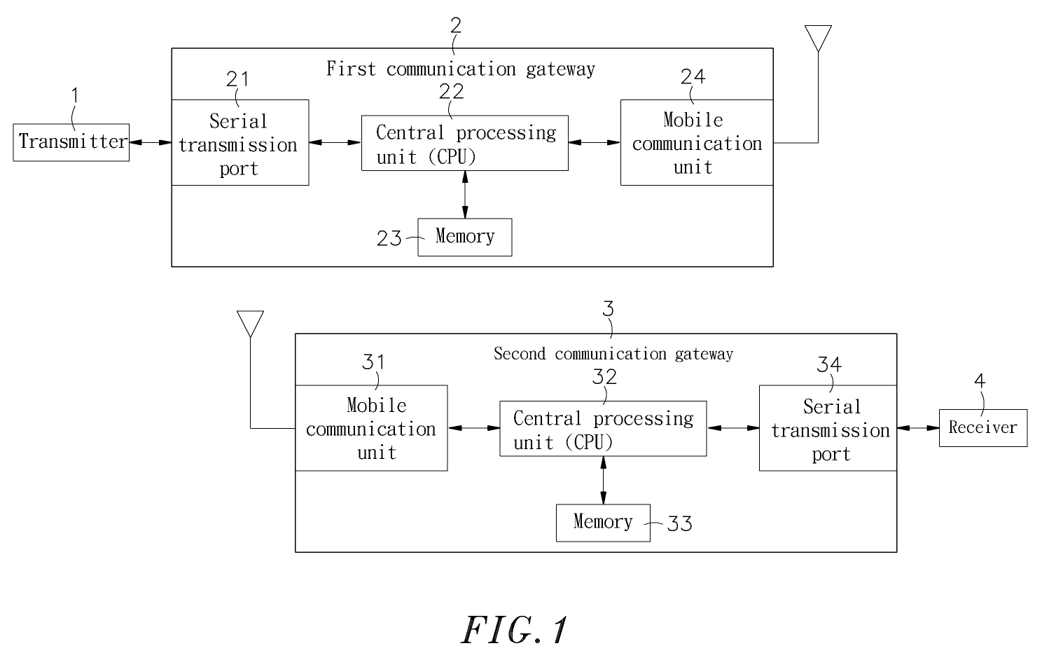

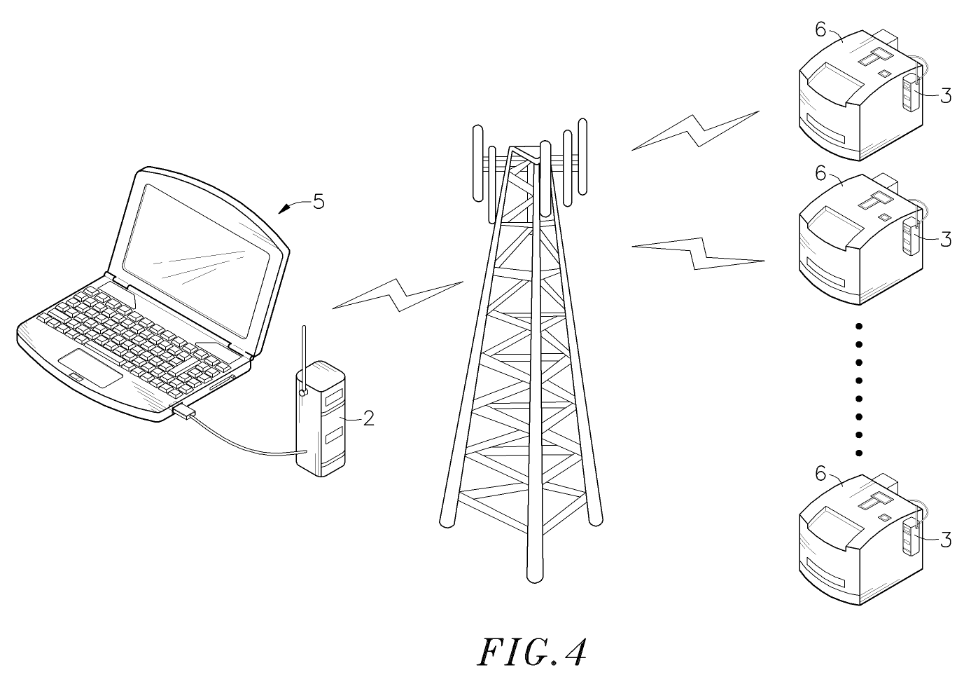

Refer to FIGS. 1 and 4, which shows that the present invention comprises a transmitter 1, a first communication gateway 2, a second communication gateway 3 and a receiver 4, wherein:

The transmitter 1 may be represented by a host computer 5 or a remote control equipment 6; and the host computer 5 may be a notebook computer, industrial computer, desktop computer or a server, etc, and the remote control equipment 6 may be a water level or debris flow monitoring device, etc.

The first communication gateway 2 is connected with the transmitter 1 through a serial transmission port 21 that is connected to a central processing unit (CPU) 22, and the CPU 22 is further linked with a memory 23 and a mobile communication unit 24.

The second communication gateway 3 receives short messages from the mobile communication unit 24 of the first communication gateway 2 via a mobile communication unit 31 which is connected with a CPU 32, and the CPU 32 is further linked with a memory 33 and a serial transmission port 34.

The receiver 4 is connected with the serial transmission port 34 of the second communication gateway 3. If the host computer 5 serves as the receiver 4 is, the remote control equipment 6 will be replaced by the transmitter 1. On the other hand, if the remote control equipment 6 serves as the receiver 4, the host computer 5 will be represented by the transmitter 1.

In the preceding paragraphs, the serial transmission ports 21 and 34 may be RS232, RS485 or transmission control protocol/internet protocol (TCP/IP) for network transmission, etc, while the mobile communication units 24 and 31 can receive the messages in a wide range of formats of mobile communication networks, including Global System for Mobile Communication (GSM), General Packet Radio Service (GPRS), Code Division Multiple Access (CDMA), Wideband Code Division Multiple Access (W-CDMA), High Speed Download Packet Access (HSDPA) or Enhanced Data Rates for GSM Evolution (EDGE), etc.

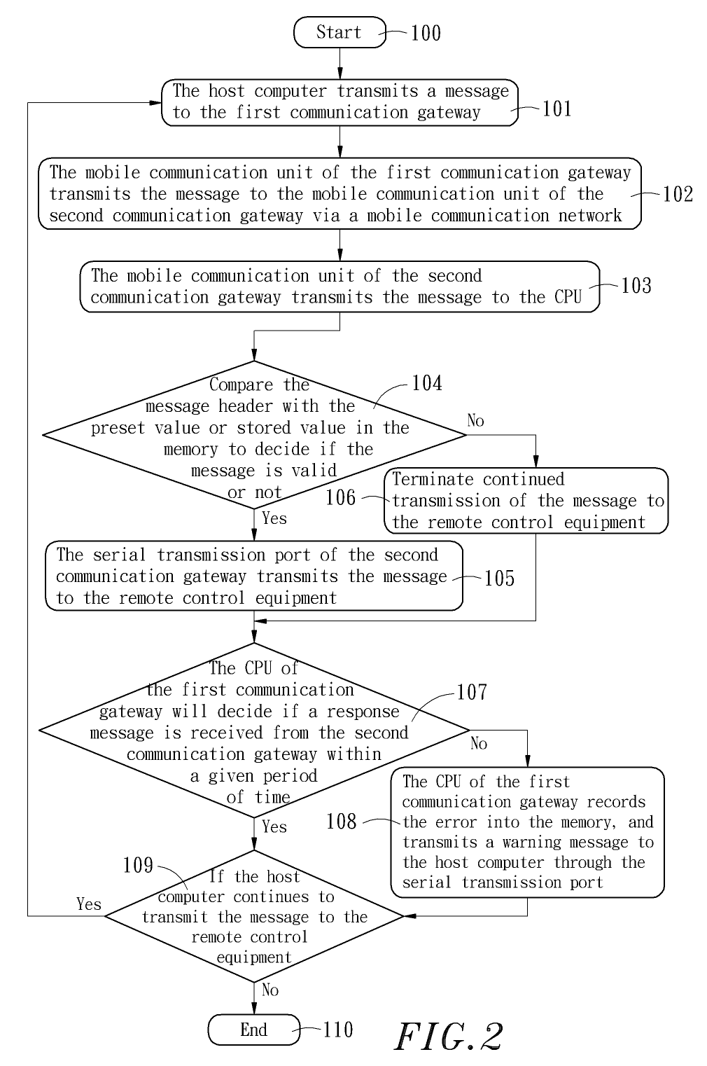

Refer to FIGS. 1, 2 and 4 simultaneously. When users try to transmit messages via the host computer 5 inside an enterprise to the external remote control equipment 6, the host computer 5 will be taken as the transmitter 1, while the remote control equipment 6 is considered as the receiver 4. The handling process is as follows:
(100) Start.
(101) The host computer 5 transmits a message to the first communication gateway 2 through the serial transmission port 21 of the first communication gateway 2.
(102) The CPU 22 of the first communication gateway 2 further transmits the message to the mobile communication unit 24, which continues to deliver the message via a mobile communication network to the mobile communication unit 31 of the second communication gateway 3.
(103) The mobile communication unit 31 then transmits the message to the CPU 32.
(104) The CPU 32 will store this message into the memory 33 and compare the header of the message with the preset or saved value in the memory 33 to determine if the message is valid or not. If so, proceed to the step (105); if not, proceed to the step (106).
(105) The CPU 32 of the second communication gateway 3 transmits the message via the serial transmission port 34 to the remote control equipment 6, proceed to the step (107).
(106) The CPU 32 will terminate continued transmission of the message to the remote control equipment 6.
(107) During a given period of time, the CPU 22 of the first communication gateway 2 will determine if it receives a response message delivered by the CPU 32 of the second communication gateway 3 via the mobile communication unit 31, mobile communication network and the mobile communication unit 24 of the first communication gateway 2 in sequence. If not, carry out the step (108); if so, proceed to the step (109).
(108) The CPU 22 of the first communication gateway 2 will record errors into the memory 23, and will deliver warning messages through the serial transmission port 21 to the host computer 5.
(109) The CPU 22 of the first communication gateway 2 will determine if the host computer 5 continually transmits the message to the remote control equipment 6. If so, carry out the step (101); and if not, carry out the step (110).
(110) End.

The example of the embodiments described above is given on the premise that the host computer 5 inside the enterprise serves as the transmitter 1, while the external remote control equipment 6 functions as the receiver 4. However, the present invention should not be construed as limited to the embodiments, where the host computer 5 or the remote control equipment 6 serves as the transmitter 1 or the receiver 4. Besides, the preset time in the step (107), which is stored in the memory 23, can be set at the discretion of designers. Therefore, the settings for the transmitter 1 and the receiver 4 or the preset value of time as mentioned above are intended to illustrate one example of the preferred embodiments of the present invention, and should not be construed as a limitation on the patent claims of the present invention.

The response message, delivered by the remote control equipment 6 through the second communication gateway 3, mobile communication network and the mobile communication unit 24 of the first communication gateway 2 in a right sequence, may be a short message or phone message. If the CPU 22 of the first communication gateway 2 receives a phone message transmitted back by the remote control equipment 6 after a given period of time, it will transmit a message to the mobile communication unit 24 for cutting off the message before another message transmission process is initiated.

If the CPU 22 of the first communication gateway 2 does not receive any response message from the receiver 4 after the given time period, it will deliver a warning message to the transmitter 1 via E-mails, SNTP Trap or active messages to notify managers for unsuccessful transmission of the message to the receiver 4.

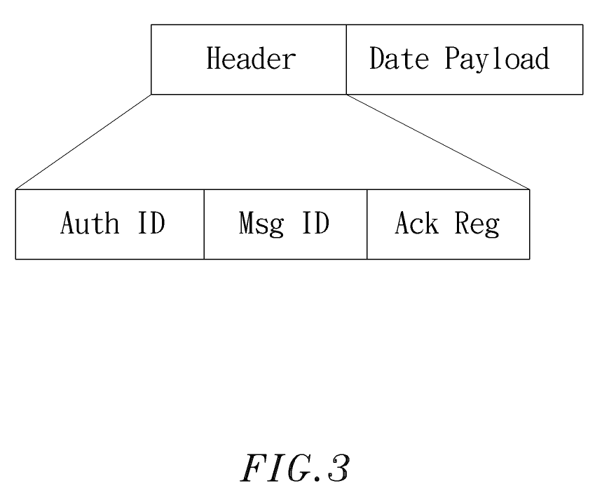

Further refer to FIG. 3, which shows the packet format of a message. Included in the header section of the message is such information as the Auth ID, Msg ID or Ack Req. Such header can be used to determine if the message is valid or not. When the second communication gateway 3 receives a message from the host computer 5, the CPU 32 of the second communication gateway 3 will decide the message is valid or not by comparing the Auth or Msg IDs with the present or stored value in the memory 33. In these cases, the Auth ID is set by the user at his own discretion. The CPU 32 will make a comparison between the Auth ID and the preset value in the memory 33 to see if there is any difference. If so, it will decide that the message is invalid. Such approach will prevent hackers' intrusion or messages from other sources other than the transmitter 1. In addition, the CPU 32 will compare the Msg IDs with the stored value when receiving many message packets continuously, and the CPU 32 will determinate whether or not the stored value is a record of a valid message transmitted; if the Msg ID is the same as the stored value, the CPU 32 will determine that the host computer 5 transmits a message repeatedly and that the message is invalid. Moreover, the Ack Req in the header indicates the way in which the CPU 32 transmits response messages to the CPU 22 of the second communication gateway 2, when the former receives messages from the latter, and includes replies or response messages, etc. If the Ack Req is not defined, it indicates that no response is required by the receiver 4.

Refer to FIG. 4 additionally. If the remote control equipment 6 serves as the transmitter 1, and is a water level or debris flow monitoring device supposedly, the host computer 5 shall serve as the receiver 4, wherein the remote control equipment 6 will transmit messages via the mobile communication network to the host computer 5 inside the enterprise. When the remote control equipment 6 delivers messages related to water level or distance of debris flow to the baseline to the host computer 5, yet the first communication gateway 2 connected with the remote control equipment 6 does not receive these messages after a certain period of time, the remote control equipment 6 will transmit these messages again. On the other hand, warning messages can also be delivered to the remote control equipment 6 to keep managers informed about the status of message transmission, so that they can solve the problems immediately.

The present invention is mainly characterized by the connections of the transmitter 1 with the first communication gateway 2 and the connections of the second communication gateway 3 with the receiver 4. When the transmitter 1 transmits a message to the receiver 4 via the first communication gateway 2, mobile communication gateway and the second communication gateway 3 sequentially, the second communication gateway 3 will deliver a response message to the first communication gateway 2 after the receiver 4 gets the message, so that the transmitter 1 can learn if the receiver 4 has received the message or not. However, for the descriptions about the host computer 5 or the remote control equipment 6 inside an enterprise as the transmitter 1 or the receiver 4, the process in which the receiver 4 determines if a message is valid or not, the way for the receiver 4 to deliver response messages and the preset time of a message transmitted from the transmitter 1 to the receiver 4, etc, all these are intended to illustrate an example of the preferred embodiments of the present invention, and can vary according to users' needs. Anyhow, this example of the embodiments of the present invention should not be construed as limitations on the patent claims of the present invention. Then, all other equivalent changes and modifications made without departing from the spirit of the art disclosed in the present invention should be included in the appended claims of the present invention.

In summary, the method for processing response messages of the present invention has the advantages as follows when applied:

(1) In the present invention, the first communication gateway 2 will determine that the receiver 4 does not receive the message if it does not get a response message from the second communication gateway 3 after a given period of time, and then will automatically transmit the message to the receiver 4 again. This can reduce the risk that message packets are lost due to network congestion or other reasons in the course of transmission. Besides, automatic re-transmission will facilitate immediate processing of the messages that are not received by the receiver 4 immediately, such as the information on the water level of a reservoir which is higher than the benchmark level or debris flows exceeding the baseline, thus reducing the damages to enterprises' assets and safety of their employees.

(2) In the present invention, the first communication gateway 2 will deliver a warning message to the transmitter 1 if it determines that no response message is received from the second communication gateway 3 after a certain period of time, thus notifying managers to perform necessary operations in a timely manner.

(3) In the present invention, the CPU 32 of the second communication gateway 3 connected with the receiver will decide if the Auth ID in the message header is the same as the value preset in the memory 33, so as to determine if transmission of the message should be continued to the receiver 4. By doing so, it can effectively avoid illegal intrusion of others or bandwidth occupation caused by surges of invalid messages in great amount into the receiver 4, thus reducing the possibilities in which messages cannot be transmitted successfully.

(4) In the present invention, the CPU 32 of the second communication gateway 3 connected with it will decide if the Msg ID in the message header is the same as the stored value, which is a valid message delivered previously. If so, the CPU 32 will decide that the message is transmitted repeatedly. In this way, it can prevent system damages and severe bandwidth payloads upon the receiver 4 as a result of continued transmissions from the transmitter 1 due to its breakdown.

In summary, the method for processing response messages of the present invention, once applied, will lead to improved functions in a remarkable way. Hence, it meets the conditions for patentability of an invention. While the application of patent is filed pursuant to applicable laws, your early approval of the present invention will be highly appreciated so as to guarantee benefits and rights of the inventor who has worked hard at this invention. For any question, please do not hesitate to inform the inventor by mail, and the inventor will try his best to cooperate with you.

What the invention claimed is:

1. A method for processing response messages comprising a transmitter, a first communication gateway, a second communication gateway and a receiver, wherein both the first and second communication gateways include a central processing unit (CPU) which is connected with a serial transmission port, a memory and a mobile communication unit. The serial transmission port of the first communication gateway is connected with the external transmitter, while the serial transmission port of the second communication gateway is connected with the preinstalled receiver. The steps of processing are as follows:
(A) Start;
(B) The transmitter delivers a message to the first communication gateway via the serial transmission port of the first communication gateway;
(C) The CPU of the first communication gateway further transmits the message to the mobile communication unit of the first communication gateway, which will send the message to the mobile communication unit of the second communication gateway through a mobile communication network;
(D) The mobile communication unit of the second communication gateway further transmits the message to the CPU of the second communication gateway;
(E) The CPU of the first communication gateway will decide if it receives a response message delivered by the CPU of the second communication gateway via the mobile communication unit of the second communication gateway, the mobile communication network and the mobile communication unit of the first communication gateway sequentially within a given period of time; if not, carry out the step (H); if so, carry out the step (I);
(H) The CPU of the first communication gateway will record an error into the memory;
(I) The CPU of the first communication gateway determines if the host computer continues to transmit the message to the remote control equipment;
if so, proceed to the step (B); if not, carry out the step (J);
(J) End.

2. The method for processing response messages according to claim 1, wherein the CPU of the first communication gateway will send a warning message via the serial transmission port to the transmitter if it does not receive a response message from the second communication gateway delivered through the mobile communication network and mobile communication unit of the first communication gateway sequentially after a given period of time.

3. The method for processing response messages according to claim 1, wherein the receiver will be remote control equipment if the transmitter is a host computer.

4. The method for processing response messages according to claim 1, wherein the transmitter will be the remote control equipment if the receiver is the host computer.

5. The method for processing response messages according to claim 1, wherein the preset time is stored in the memory.

6. The method for processing response messages according to claim 1, wherein the message has a header that contains an Ack Req.

7. The method for processing response messages according to claim 6, wherein the Ack Req contains such request as an Msg ID or phone message.

8. The method for processing response messages according to claim 7, wherein the CPU of the first communication gateway will transmit a message to the mobile communication unit of the first communication gateway for cutting off the message from the second communication gateway if the Ack Req is a telephone number.

9. The method for processing response messages according to claim 1, wherein the message has a header section which further contains the Auth ID or Msg ID.

10. The method for processing response messages according to claim 9, wherein the Auth ID is included in the header, and after having received the message, the CPU of the second communication gateway will save it into the memory, and compare the Auth ID in the header with the preset value in the memory to decide if the message is valid or not, if they are just the same, the CPU will decide that the message is valid and deliver the message to the receiver via the serial transmission port, otherwise, the CPU will consider the message as invalid and terminate its continuous transmission to the receiver.

11. The method for processing response messages according to claim 9, wherein the message header contains a Msg ID, after having received the message, the CPU of the second communication gateway will save it into the memory, and compare the Msg ID in its header with the value stored in the memory to determine if the message is valid or not, where the stored value is a record of valid messages delivered, if there is difference between them, the CPU will determine that the message is valid and transmit it to the receiver through the serial transmission port, if there is no difference, the CPU will consider it as invalid and terminate its continued transmission to the receiver.
